(19) United States
(12) Patent Application Publication
(10) Pub. No.: US 2024/0318625 A1
(43) Pub. Date: Sep. 26, 2024

(54) AERODYNAMIC CONTROL DEVICES FOR DUCTED FLUID TURBINES

(71) Applicant: Vincent Loccisano, Wellesley, MA (US)

(72) Inventor: Vincent Loccisano, Wellesley, MA (US)

(21) Appl. No.: 18/613,544

(22) Filed: Mar. 22, 2024

Related U.S. Application Data
(60) Provisional application No. 63/491,872, filed on Mar. 23, 2023.

(51) Int. Cl. F03D 1/04

(52) U.S. Cl. CPC F03D 1/053; F03D 1/042; F03D 1/051; F05B 2240/13

(57) ABSTRACT

A fluid-turbine system has an improved means of mitigating the effects of excessive fluid velocity on turbine structural components. Spoilers provide a simple mechanical solution that reduces lift, with minimal increase in drag. Spoilers installed on a duct control aerodynamic lift on ducted turbines, specifically in high-wind conditions. An example embodiment comprises a ducted (shrouded) turbine with articulated segments or spoilers, which may be raised toward the central axis. These spoilers reduce or maintain a tower base moment as constant and dampen support structure oscillations.

### TECHNICAL FIELD

The present disclosure relates in general to fluid turbine systems having a shroud assembly with increased protection for turbine structural components in excessive fluid velocity conditions; and more specifically, to shrouds having aerodynamic control devices such as spoilers on the inner surface of the shroud assembly.

### BACKGROUND

Some conventional horizontal-axis fluid turbines have two to five open blades arranged like a propeller, with the blades mounted to a horizontal shaft attached to a gear box which drives a power generator. Conventional fluid turbines often comprise blades with pitch control for the purpose of furling the blades into the wind to mitigate speed and torque on the generator in excessive fluid velocity conditions. These further provide a means of regulating the power output of a turbine or group of turbines.

Excessive fluid-velocity events can cause various types of asymmetrical loading on the tower and rotor plane. Asymmetrical loading can cause oscillations that cause stress on a turbine's support structure or electrical-generation equipment. By furling turbine blades into the fluid stream in the highly loaded regions of the rotor plane, and out of the wind in the lesser-loaded regions of the rotor plane, oscillations and excessive thrust force on the tower, and excessive torque on the generator, can be mitigated.

A substantially annular duct that is in fluid communication with a rotor is referred to as a turbine shroud. Ducts surrounding a rotor plane are known to improve power extraction over that of an open rotor. One skilled in the art understands that a properly designed duct delivers greater mass-flow rate to the interior of the duct than to the exterior. Improved performance over that of a similar open rotor, from a rotor in fluid communication with a properly designed duct, may be achieved due to a reduction of rotor-tip vortices and the increased unit mass-flow through the duct.

An aerodynamic control device installed on a duct may further mitigate rotational forces caused by excessive lift on aerodynamic surfaces during excessive fluid-velocity events.

A spoiler is a device intended to reduce lift of an airfoil. An airfoil comprises a lift or suction side and a pressure side. On an aircraft wing, the upper surface is the “lift” side of the airfoil, and the lower surface is the “pressure” side. In a ducted turbine, the lift surface of the airfoil is on the interior of the duct, proximal to the rotor. A spoiler is any surface extending upward with respect to, or perpendicular to, the lift surface of the airfoil. When extended or otherwise deployed, the spoiler creates a controlled stall over the section of airfoil that is downwind of the spoiler. This significantly reduces lift, with minimal increase in drag.

Reference to “support structure” or “tower” is intended to include all structures used in orientating and supporting a turbine assembly.

The aerodynamic principles of a ducted turbine are not restricted to air and apply to any fluid, including liquid, gas or combination thereof. For convenience, the present embodiment is described in relation to a ducted wind-turbine application.

### SUMMARY

A fluid turbine system has an improved means of mitigating the effects of excessive fluid velocity on turbine structural components. Spoilers provide a simple mechanical solution that reduces lift, with minimal increase in drag. Spoilers installed on a duct control aerodynamic lift on ducted turbines, specifically in high-wind conditions.

An example embodiment comprises a ducted (shrouded) turbine with articulated segments that may be raised toward the central axis. Articulated segments, hereafter referred to as “spoilers,” refer to sections of the airfoil surface or elements within the surface that may be actuated in a rotational or linear direction.

In an embodiment, turbine-support structure or tower stress may be measured by measuring tower-base moment or indicators thereof, including tower-top acceleration, tower tilt or rotor-power output. Spoilers are deployed to reduce or to maintain a tower base moment as constant. In a similar manner, tower or support structure oscillations can be dampened.

In situations where yaw stabilization fails in high wind speeds, lift forces on portions of the ringed airfoil result in thrust forces that can result in excessive torque and rotation of the ducted turbine about the yaw axis. Spoilers are configured to mitigate lift forces on portions of the ringed airfoil to reduce or eliminate torque about the yaw axis of the turbine.

Individual spoilers can also be utilized to apply a yaw moment to yaw the turbine upwind or downwind, and to control rotation of the turbine about the vertical axis.

Another embodiment comprises a turbine shroud combined with a mixer/ejector shroud. In this embodiment the trailing edge of the turbine shroud is in fluid communication with a second ringed airfoil, referred to as an ejector shroud. The turbine and ejector shroud share a central axis along the center of the cylindrical-airfoil shapes. An ejector shroud is designed with a lift surface on the interior of the ringed airfoil and a pressure surface on the exterior of the ringed airfoil to introduce an additional fluid stream into the wake of the turbine. A highly cambered airfoil is designed to expand the wake behind the turbine, enabling continuous, increased mass flow through the rotor plane.

Both turbine shroud and ejector shroud may comprise spoilers to reduce lift on the interior surface of the shrouds and to provide a means of yawing the turbine or stabilizing the yaw direction of the turbine in excessive wind conditions.

### BRIEF DESCRIPTION OF THE DRAWINGS

FIG. 1 is a front, right, perspective view of an exemplary embodiment of a shrouded fluid turbine.

FIG. 2 is a front, right, perspective, view of the embodiment of FIG. 1.

FIG. 3 is a side, orthographic, detailed, section view of the fluid turbine of FIG. 1.

FIG. 4 is a side, orthographic, detail, section view of the embodiment of FIG. 1.

FIG. 5 is a top cross-section view of the fluid turbine of FIG. 1 with spoilers retracted.

FIG. 6 is a top cross-section view of the fluid turbine of FIG. 1 with spoilers deployed.

FIG. 7 is a top cross-section view of an iteration of the embodiment with spoilers retracted.

FIG. 8 is a top cross-section view of the fluid turbine of FIG. 7 with spoilers deployed.

FIG. 9 is a front, right perspective view of an iteration of the embodiment including a turbine shroud and an ejector shroud.

FIG. 10 is a side, detail, cross-section view of the embodiment of FIG. 9 with spoilers retracted.

FIG. 11 is a side, detail, cross-section view of the embodiment of FIG. 9 with spoilers deployed.

### DETAILED DESCRIPTION

The figures presented here demonstrate the present disclosure and are not intended to show relative sizes and dimensions or to limit the scope of the exemplary embodiments.

The term “about” when used with a quantity includes the stated value and also has the meaning dictated by the context. For example, it includes at least the degree of error associated with the measurement of the particular quantity. When used in the context of a range, the term “about” should also be considered as disclosing the range defined by the absolute values of the two endpoints. For example, the range “from about 2 to about 4” also discloses the range “from 2 to 4.”

For convenience, the “articulated shroud segments” or “spoilers” of the present invention shall be described as being actuated and may be pivoted about a “pivot point,” may be pivoted about a “pivot axis,” or may be deployed and retracted from within the shroud by way of a linear actuator. The method, system and apparatus of the present invention may be practiced using a variety of suitable means for providing an articulated surface suitable for practicing the present invention.

A properly designed ducted rotor delivers greater mass flow rate to the interior of the duct than to the exterior. Improved performance over that of a similar open rotor, from a rotor in fluid communication with a properly designed duct, may be achieved by a reduction of rotor-tip vortices and increased unit mass-flow through the duct.

A shrouded turbine is an improved means of generating power from fluid currents. The shrouded turbine includes tandem cambered shrouds. The primary shroud surrounds the swept area of a rotor, which extracts power from a primary fluid stream. The tandem cambered shrouds draw increased mass flow through the rotor, enabling relatively greater energy extraction due to higher flow rates. An ejector transfers energy from the bypass flow to the rotor-wake flow, enabling a higher energy-per-unit-mass-flow rate through the rotor. These two effects enhance the overall power production of the wind-turbine system.

The term “rotor” is used herein to refer to any assembly in which one or more blades are attached to a shaft and able to rotate, enabling the extraction of power or energy from wind rotating the blades. Exemplary rotors include propeller-like rotors or rotor/stator assemblies. In this disclosure, any type of rotor may be enclosed in the turbine shroud.

The leading edge of a turbine shroud may be considered the front, and the trailing edge of an ejector shroud may be considered the rear of the fluid turbine. A first component of the fluid turbine, located closer to the front of the turbine, may be considered “upstream” of a second, “downstream” component closer to the rear of the turbine.

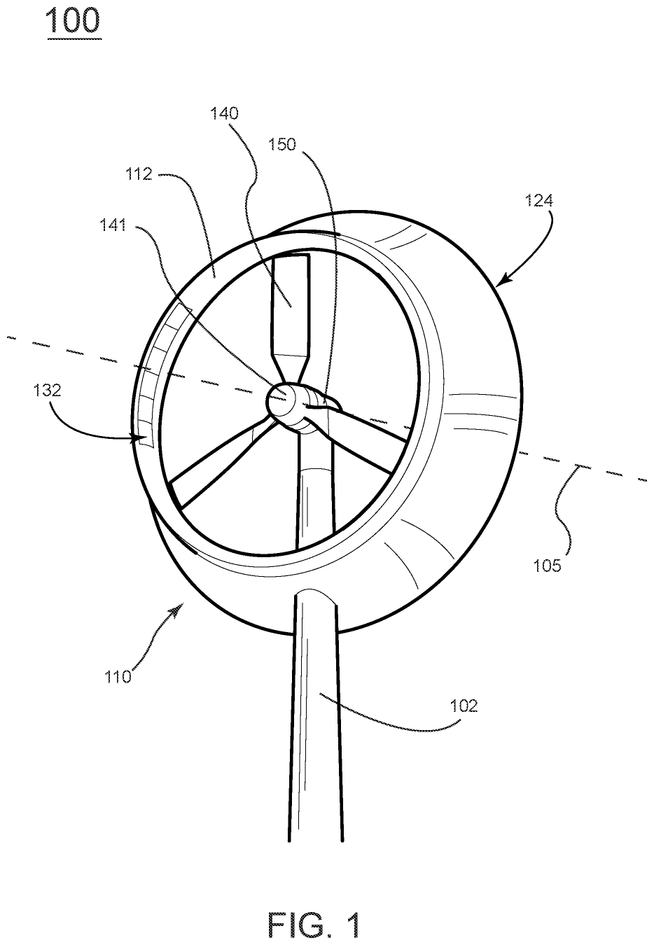

In FIG. 1, a shrouded fluid turbine 100 comprises a turbine shroud 110, a nacelle body 150 and a rotor 140. The turbine shroud 110 has a front end 112, also known as an inlet end or a leading edge, and a rear end 124, also known as an exhaust end or trailing edge. The rotor 140, nacelle 150, and shroud 110 share a common axis 105. At least one spoiler 132 is engaged with or derived from at least one section of the lift surface of the ringed airfoil.

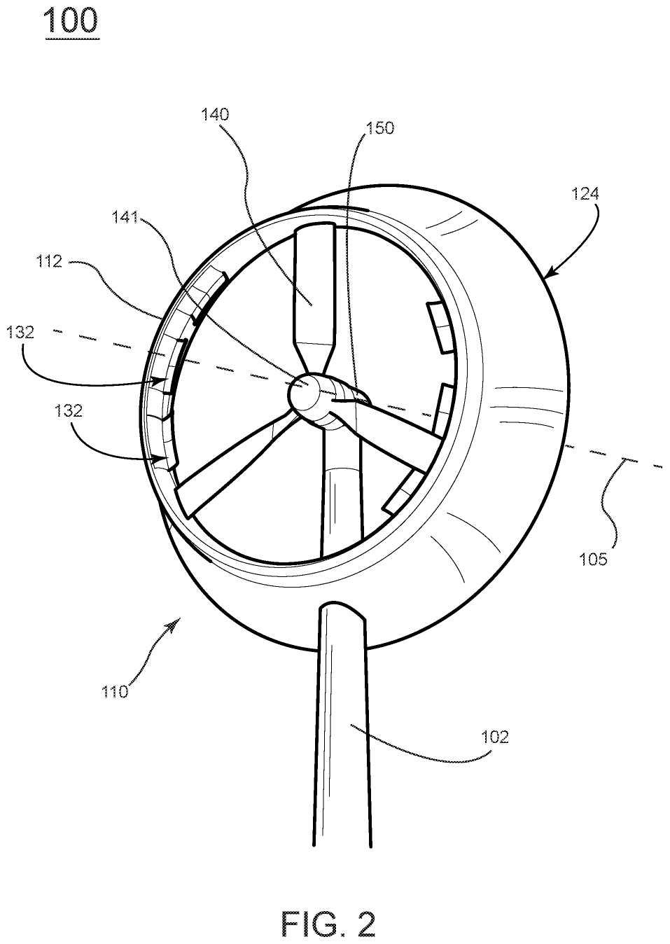

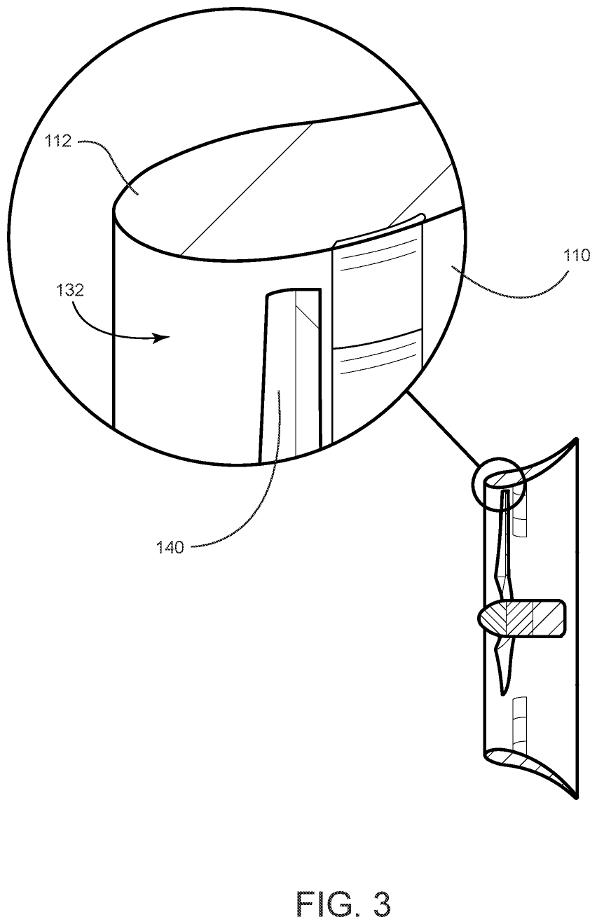

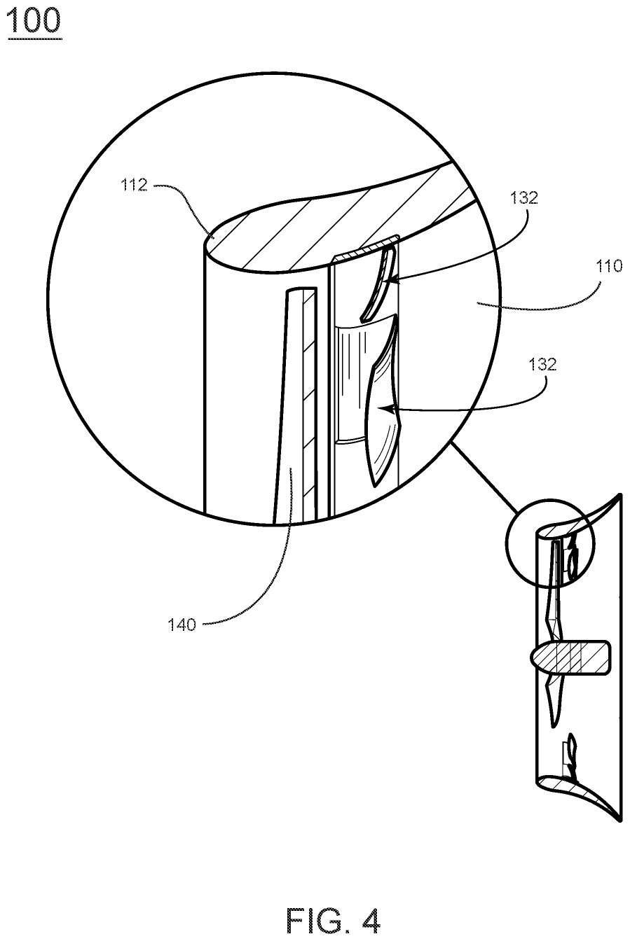

The illustrations in FIG. 2, FIG. 3 and FIG. 4 illustrate the shrouded turbine 100 with spoilers 132 retracted and deployed. Similar reference numbers refer to similar components. FIG. 2 shows spoilers 132 located proximal to the 3 o'clock and 9 o'clock positions of the rotor plane, in a deployed state. In a detail view of the embodiment 100 of FIG. 2, FIG. 3 shows spoilers, located proximal to the 3 o'clock and 9 o'clock positions of the rotor plane, in a retracted state. In a top, cross-section, detail view of the embodiment 100 of FIG. 2, FIG. 4 shows spoilers in a deployed state. Spoilers mitigate or eliminate aerodynamic forces that cause torque on the turbine yaw axis in high-wind conditions.

One skilled in the art understands that spoilers may be located forward or rearward of the rotor, and that the articulation of the spoiler may be actuated mechanically, pneumatically or passively. During normal operation, such articulated segments may be held in in place under tension as by a torsion spring and maintained in place by an interference mechanism, such as a pin. In such a configuration, spoilers may be rapidly deployed by removing the interference mechanism to release the tension, for example by removing the pin to release the torsion spring. Other example embodiments may include a mechanical or pneumatic actuation of the spoilers that are not under tension during normal operation of the turbine. In another iteration, spoilers may be designed such that wind flowing along the central axis 105, at normal wind speeds, keeps the spoilers retracted. Wind flowing off-axis or at extreme wind speeds causes spoilers to deploy.

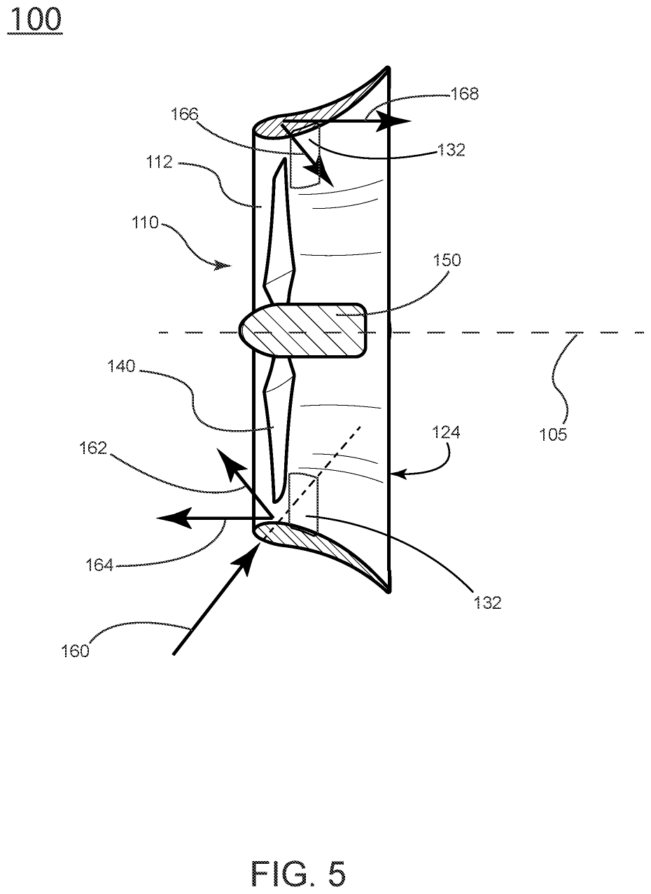

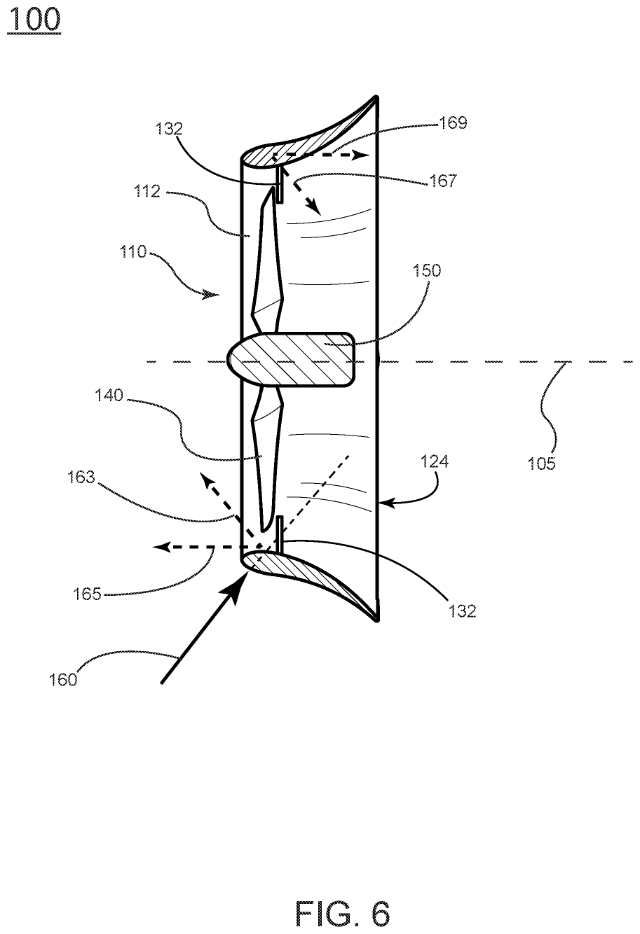

The turbine shroud has a cross-sectional shape of an airfoil. Its suction side (or low-pressure side) is on the shroud's interior. FIG. 5 and FIG. 6 show the turbine shroud 110 with spoilers in the retracted position (FIG. 5) and in the open position (FIG. 6). Wind flowing in the direction indicated by arrow 160 causes a lift force arrow 162 on the upwind side of the turbine. A component of the lift force 162 is a forward-thrust force indicated by arrow 164. Wind flowing in the direction indicated by arrow 160 continues to the downwind side of the turbine and results in a secondary lift force arrow 166 with a resultant force arrow 168. The turbine 100 pivots about a yaw axis, approximately at the center of the nacelle 150. The combined forces plus turbine pivot result in torque about the yaw axis. In a high-wind event, the torque can be sufficient to cause traditional yaw-braking systems to fail.

FIG. 6 shows the spoilers deployed. Wind flowing in direction 160 encounters at least one deployed spoiler 132 on the shroud's 110 upwind section. The spoiler reduces lift 163 and eliminates the thrust force 165. Wind flowing in direction 160 encounters the additional spoilers on the downwind airfoil. These spoilers reduce the lift force 167 and cause drag in direction 169. Spoilers, when deployed, mitigate or eliminate the aerodynamic forces that cause torque about the turbine yaw axis in high-wind conditions. In the example embodiment 100 spoilers 132 are deployed and retracted about a pivot axis. One skilled in the art understands that spoilers 132 may pivot about an axis as shown or may pivot about a pivot point, a hinge, or the like.

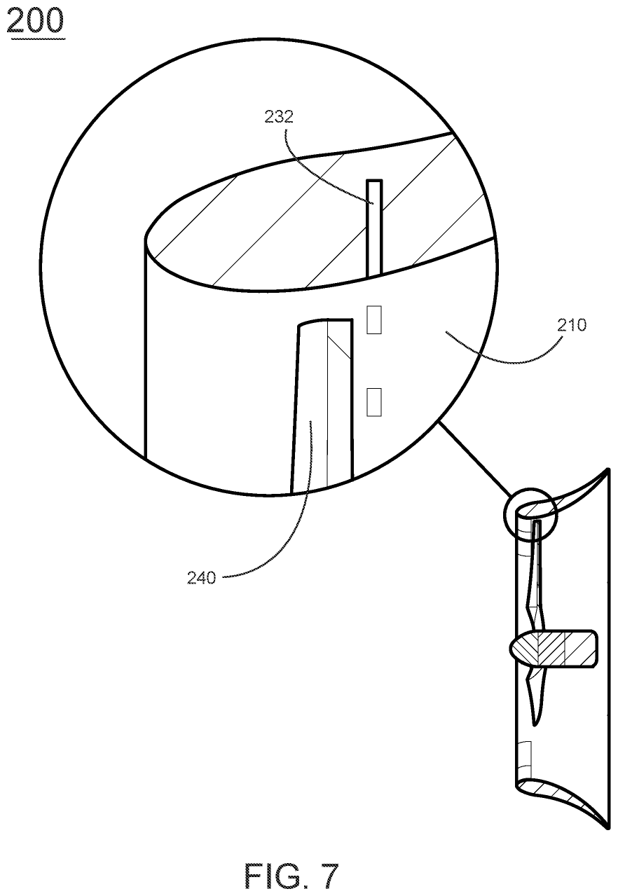

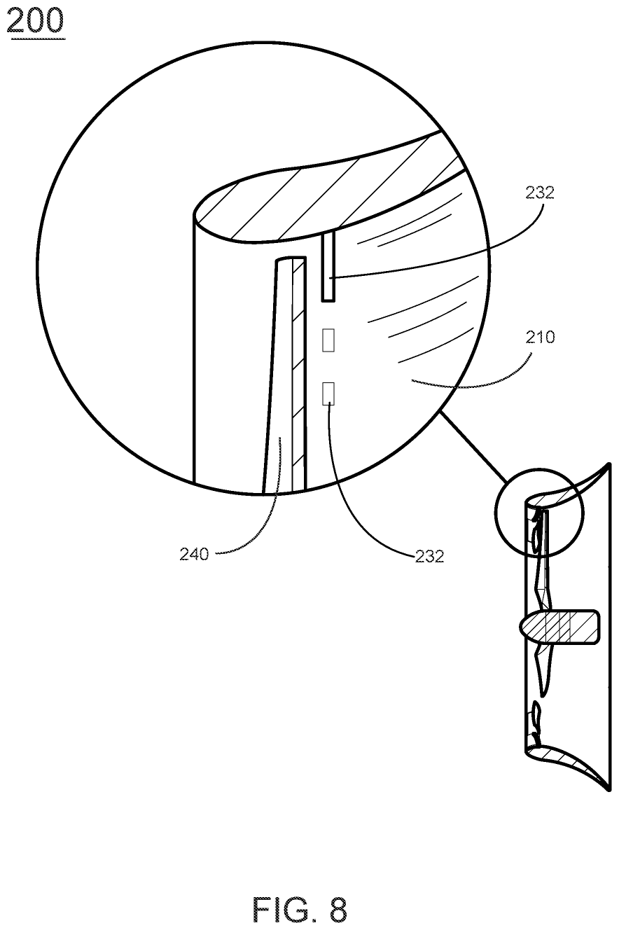

In an iteration 200 of the embodiment, FIG. 7 and FIG. 8 show spoilers 232 are retracted inside the body of the ringed airfoil 210 and are deployed by linear motion. The turbine shroud 210 surrounds a rotor 240. Spoilers 232 function in the manner described in FIG. 5 and FIG. 6, but are deployed by linear motion. One skilled in the art understands that a spoiler 232 may be deployed by a linear actuator or other mechanical drive or may be held under tension by an interference mechanism and deployed upon release of the interference mechanism.

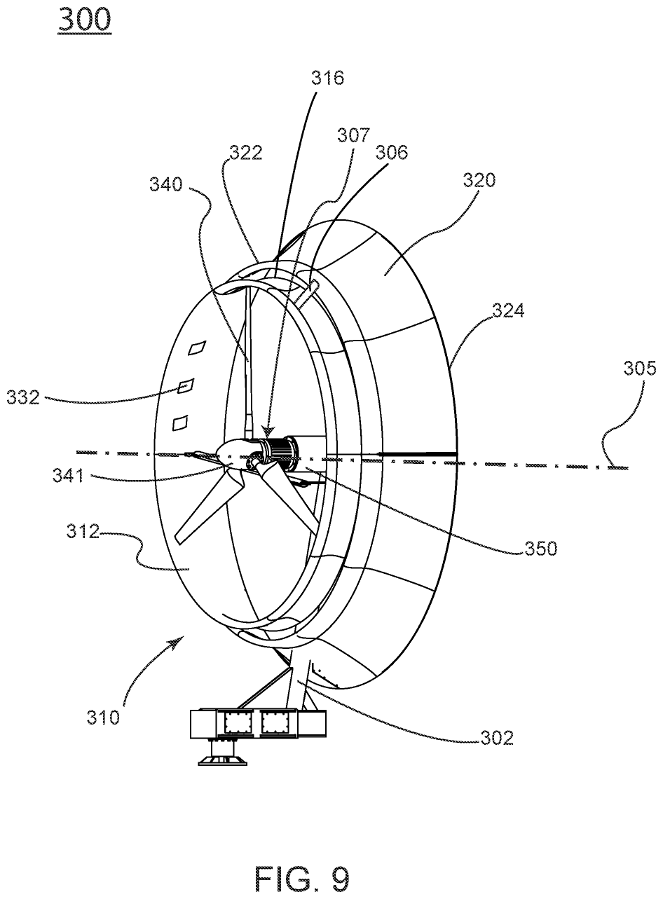

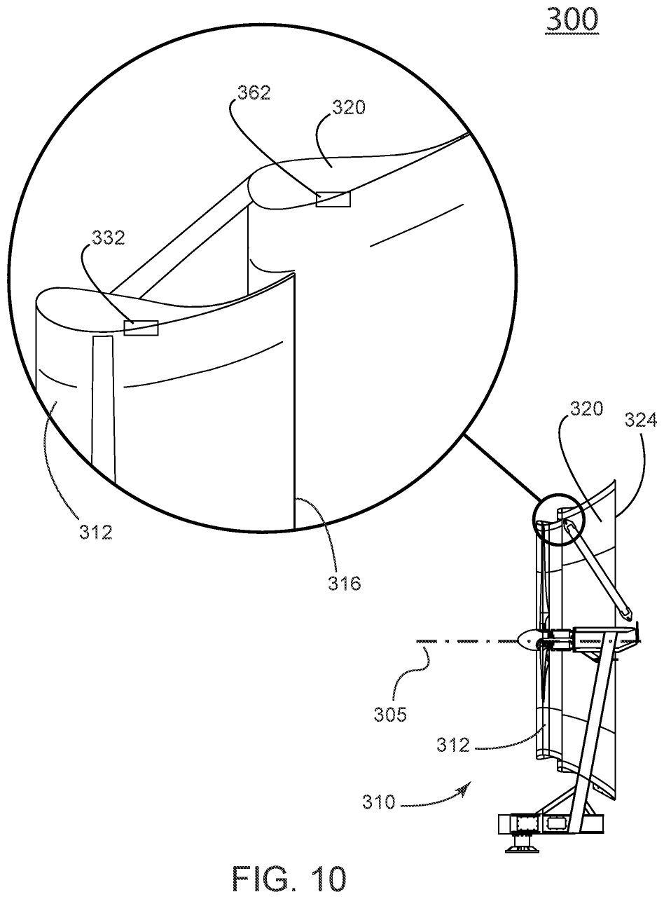

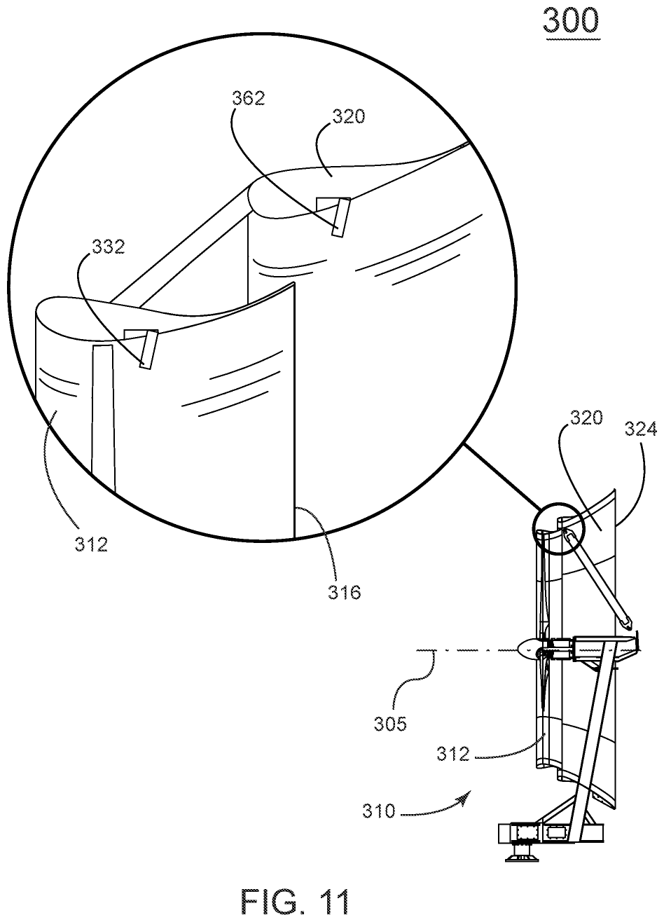

In an additional embodiment 300, FIG. 9 and FIG. 10 show the shrouded fluid turbine of FIG. 9 with spoilers retracted. FIG. 11 is detailed, section view showing the spoilers deployed.

FIG. 9, FIG. 10 and FIG. 11 show the shrouded fluid turbine 300 comprising a turbine shroud 310, a nacelle body 350, a rotor 340, and an ejector shroud 320. The turbine shroud 310 includes a front end (also referred to as inlet end or a leading edge) 312. The turbine shroud 310 also includes a rear end 316, also known as an exhaust end or trailing edge. The ejector shroud 320 has a front end (also referred to as inlet end or leading edge) 322, and an exhaust end or trailing edge 324. A rotor 340 surrounds a nacelle body 350, with a central hub 341 at the proximal end of the rotor blades. The central hub 341 is rotationally engaged with the nacelle body 350. The nacelle body 350 and the turbine shroud 310 are supported by a tower 302. The nacelle body 350, central hub 341, rotor 340, turbine shroud 310, and ejector shroud 320 share a central axis 305.

At least one spoiler 332 on at least one section of the turbine shroud 310 is articulated in a rotational or linear direction so as to be deployed as shown in FIG. 11. At least one spoiler 362 on at least one section of the ejector shroud 320 is articulated similarly.

Articulation of the aforementioned at least one spoiler 332 may be active, passive or some combination thereof. Spoilers may be activated by user input or may be automatically actuated according to data gathered from one or more suitable sensors deployed within the shrouded-turbine assembly. One skilled in the art recognizes that spoilers 332 and spoilers 362 may be engaged with the ejector shroud 320 or with the turbine shroud 310.

Although only a few example embodiments have been described in detail above, those skilled in the art will readily appreciate that many modifications are possible in the example embodiments without materially departing from this invention.

1. A fluid turbine comprising:
a rotor rotationally engaged with a generator on a shared central axis; and
at least one annular duct, having an inner surface and an outer surface, coaxial with said central axis; and
at least one spoiler fixedly engaged with said inner surface of said at least one annular duct; wherein
said spoiler is contiguous with said at least one annular duct inner surface, and may be deployed by moving away from said inner surface.

2. The fluid turbine of claim 1 wherein:
said duct has an airfoil cross-section.

3. The fluid turbine of claim 1 wherein:
said duct is in fluid communication with, and surrounding, a perimeter of a swept area of said rotor.

4. The fluid turbine of claim 1 wherein:
said spoiler is engaged with a pivot axis at a first end and is movable about a second end; and
said first end is downwind of said second end; wherein
said spoiler is deployed by pivoting on said pivot axis, and moving away from said at least one annular duct inner surface.

5. A fluid turbine comprising:
a rotor rotationally engaged with a generator on a shared central axis; and
at least one annular duct having an inner surface and an outer surface coaxial with said central axis; and
at least one spoiler fixedly engaged with said inner surface of said at least one annular duct; and
said spoiler having at least a first surface that is contiguous with said at least one annular duct inner surface; and
said spoiler is movably engaged with a linear actuator; wherein
said spoiler is deployed as said linear actuator moves said spoiler in a linear motion, moving said at least a first surface away from said at least one annular duct inner surface.

6. The fluid turbine of claim 5 wherein;
said spoiler, when deployed, moves in a linear direction perpendicular to said central axis.

7. A fluid turbine comprising:
a rotor rotationally engaged with a generator on a shared central axis; and
at least a first annular duct having a leading edge and a trailing edge, and an inner surface and an outer surface, coaxial with said central axis; and
at least a second annular duct having a leading edge and a trailing edge and an inner surface and an outer surface coaxial with said central axis; and
said at least a second annular duct leading edge in fluid communication with said at least a first annular duct trailing edge; and
at least one spoiler fixedly engaged with said inner surface of said at least a first annular duct; wherein
said spoiler resides contiguous with said at least one duct inner surface and may be deployed by moving away from said inner surface.

8. The fluid turbine of claim 7 further comprising:
said spoiler is contiguous with said at least one duct inner surface and is under tension and held fast by an interference mechanism; wherein
removal of said interference mechanism deploys said spoiler.

9. The fluid turbine of claim 7 further comprising:
at least one spoiler fixedly engaged with said inner surface of said at least a second annular duct.

10. The fluid turbine of claim 8 wherein:
at least one spoiler fixedly engaged with said inner surface of said at least a second annular duct is held under sufficient tension to remain retracted in normal wind conditions, and to deploy in excessive wind conditions.
